(19) United States
(12) Patent Application Publication
(10) Pub. No.: US 2003/0063892 A1
(43) Pub. Date: Apr. 3, 2003

(54) Broadband source with transition metal ions

(76) Inventors: George H. Beall, Big Flats, NY (US); Nicholas F. Borrelli, Elmira, NY (US); Karen E. Downey, Ithaca, NY (US); Linda R.. Pinckney, Corning, NY (US); Bryce N. Samson, Horseheads, NY (US)

Correspondence Address: CORNING INCORPORATED, SP-TI-3-1, CORNING, NY, 14831

(21) Appl. No.: 10/138,770

(22) Filed: May 3, 2002

Related U.S. Application Data
(60) Provisional application No. 60/288,518, filed on May 3, 2001.

(51) Int. Cl. G02B 6/16; G02B 6/10; G02B 1/00

(52) U.S. Cl. 385/141; 385/123; 385/129; 359/342; 359/350

(57) ABSTRACT

A broadband source, including associated devices that may incorporate the broadband source, which makes use of at least one, preferably two or more broad fluorescence spectra in combination from one or more species of transition metal ions doped in one or more material bodies. The bodies are selected from crystalline, glass-ceramic, glass, or polymer-organic materials. The broadband source or devices can generate a very broad fluorescence spectrum. The combined spectrum preferably spans a wavelength range of about 500 nm to 600 nm to 700 nm, and having an intensity that does not deviate from an average intensity by more than about 10 dB, over a range or portion of the near infrared region.

### CLAIM OF PRIORITY

The present Application claims benefit of priority of U.S. Provisional Application No. 60/288,518, of the same title, filed on May 3, 2001, the content of which is incorporated herein by reference.

### BACKGROUND

Broadband sources, particularly in the infrared region from about 700 nm to about 1800 nm, are used in numerous applications in a number of industries, including the photonic, optical transmission (including optical fibers), and biological imaging systems. A broadband source is useful for providing a relatively wide fluorescence half-width. A broadband source ideally would combine characteristics of high brightness or optical intensity, flat spectral response and broad bandwidth, covering all parts of the spectrum and be inexpensive to make or operate, and be physically robust, and optically stable.

A number of different kinds of technologies are used currently to create light emissive sources. First, one kind of technology is a thermal or white light (e.g., tungsten filament) source, which exhibits a very flat spectral response but relatively low intensity when coupled with single-mode fiber. A second kind, perhaps the most commonly used technology, is fiber pigtailed edge light emission diode (ELED) sources, which often combine the output from more than one device to produce a broad spectral output. A third kind of technology employs rare earth doped fiber amplified spontaneous emission (ASE) sources. More recently, a fourth kind, continuum generation from non-linear interactions between fibers and ultra short pulses from laser sources has been developed.

These current technologies, however, fail to meet in some aspect many or all of the desirable parameters for a broadband source. The low intensity of light achievable from thermal or white-light sources rules them out for many applications, since their relatively poor dynamic range ultimately gives rise to poor signal to noise ratios, hence requiring long averaging times for many applications. This particular shortcoming isn't as great a problem in the technologies based on semiconductor ELEDs and rare earth-doped fiber ASE sources, but any improvement in signal to noise ratios have been at the expense of limited bandwidth. Typical commercial devices of the second kind of technology use four ELEDs to produce an output that spans the 1100-1600 nm region. Although the average intensity is far superior to that obtained from thermal-white-light based sources, their emission spectrum has, unfortunately, significant intensity ripples of typically more than 10 dB, over the full output spectrum of the sources. The third kind of technology or ASE sources offer higher intensity and fairly flat spectral characteristics, but only over very limited, narrow bandwidths of approximately 30-40 nm, as for example an erbium ASE source. Combinations of many ELEDs and fiber ASE sources can be conceived, but inevitably the spectral flatness is sacrificed to extend their useable bandwidth. Finally, although the continuum generation of ultra short pulse interactions in selected fibers has received attention, this kind of technology requires a very expensive pulsed source, such as femtosecond laser technology. Further, the pulsed sources may not be as robust, stable or compact as alternative sources.

The present invention addresses each of these concerns and can offer various advantages over these other technologies. The present invention in one aspect combines the brightness and coherence of continuous wave sources, such as the ELED/fiber ASE sources, with the flatness of the white light source, over a bandwidth covering the near IR portion of the spectrum (˜700-1800 nm). In another aspect devices according to the present invention have the stability, robustness and compactness inherent in an all-fiber based technology (e.g., diode pumped, utilizing fiber based components) coupled with a low manufacturing cost relative to ultra-short pulse sources.

### SUMMARY OF THE INVENTION

According to the present invention, we show the potential for a new broadband source, with an intensity, bandwidth, and spectral fluorescence having a relative flatness or level far superior to that which is achievable or available from any of the current technologies. The present invention in one embodiment encompasses, a broadband source comprising at least one material body containing at least one or more species of transition-metal ions. The source produces a broad output spectrum of about at least 150-250 or 300 nm bandwidth in a near infrared region, when optically energized. When two or more bodies or devices are employed together, the source produces a broad combined-output spectrum of a relatively level intensity in a near infrared region. The source body may comprise a material selected from the group consisting of crystalline, glass-ceramic, glass, and organic-polymer matrices. Preferably, the source has a body made from a glass-ceramic material, such as transparent forsterites or gallate spinels. The transition-metal ions are preferably selected from a group of metals consisting of: Co, Cu, Cr, Fe, Mn, Ni, Sc, Ti, V, Zn. Preferably, said transition-metal ions are selected from a group consisting of: Co⁺³ Cr⁺³, Cr⁺⁴, Ni⁺², Ti⁺³, V⁺². One embodiment of a broadband source produces or emits a combined spectrum having an intensity that does not deviate from an average intensity by more or less than about 10 dB, over sections of a range from about 700 nm to about 1800 nm. More preferably, the said intensity does not deviate from said average intensity by more than about 5 dB. Preferably, the source produces a relatively level, combined-output spectrum between about 500-700 nm to about 980 nm, or 1050 nm to about 1580 nm. The broadband source further comprises rare-earth ions in said body, wherein said rare earth ions include Er, Tm, Pr, or Nd.

The present invention also includes a device incorporating the broadband source material having a broad bandwidth. The device may comprise a material doped with transition-metal ions that exhibit relatively broad fluorescence half-widths in a range of about at least 150 or 180-250 or 300 nm. Alternatively, when two or more broadband source materials are combined, the device may emit a combined output spectrum with an intensity that does not deviate from an average intensity by more or less than about 10 dB over a possible range of about 1,000 nm, from about 700 or 800 nm to about 1700 or 1800 nm. The device can be a variety of optical components, for example, an optical fiber, waveguide, amplifier, or optical energizer (laser). U.S. Pat. No. 6,297,179, by Beall et al., discusses optical fibers, amplifiers, and energizers (lasers) in detail, the content of which is incorporated herein by reference. The device may also be used for optical coherence tomography (OCT) or optical coherence domain reflectometry (OCDR).

Another aspect of the present invention encompasses a method for making a broadband source. The method comprises: providing a material containing transition-metal ions, forming said material into an optical component, energizing the transition metals in said material, and emitting a broad, combined fluorescence having an intensity that does not deviate from an average intensity by more or less than about 10 dB, in a spectral region greater than or equal to about 700 nm. The method may further comprise providing two or more bodies containing more than one species of transition metal ions. Alternatively an embodiment of the broadband source may also be made from at least two different kinds of material bodies doped with the same kinds of transition metal ions.

The invention also includes a method of producing an optical emission in a device comprising providing a body including at least two species of transition metal ions, energizing the body to produce a relatively broad combined-output spectrum of a relatively level intensity, in a near infrared region. The method may further comprise producing an emission that has an intensity that does not deviate from an average intensity by more than about 10 dB or less, between a spectrum range from about 900-1560 nm. The method also may include providing a body made from a material selected from the group consisting of crystalline, glass-ceramic, glass, and organic-polymer matrices. Preferably, the body is made from a glass ceramic material. The material may be doped with transition metal ions selected from a group consisting of: Co⁺³, Cr⁺³, Cr⁺⁴, Ni⁺², Ti⁺³, V⁺².

### BRIEF DESCRIPTION OF THE FIGURES

FIG. 1 shows, in comparison, respective emission spectra of Cr- and Ni-doped optical fibers.

FIG. 2 shows, according to an embodiment of the present invention, the control of a combined-output spectrum by variably adjusting relative pump powers for each of transition metal ions in the fibers according to FIG. 1, to achieve an optimized combined spectrum.

FIG. 3 shows output spectrum of an embodiment of the present invention as compared with two examples of current light emission techniques.

FIG. 4 shows two output spectra of embodiments of the present invention in comparison using Cr- and Ni-doped fibers energized at 980 nm and 820 nm, and pumped at slightly different intensities.

FIG. 5A is a schematic representation of a pump splitter coupler device.

FIG. 5B is a schematic representation of an alternative laser device.

FIG. 6 shows the fluorescence spectra of another embodiment of the present invention, in which the same kind of transition metal ions is incorporated into two different kinds of material bodies.

FIG. 7 shows a combined spectrum of Cr and Ni doped in a forsterite glass-ceramic according to one compositional embodiment with Cr levels at about 0.10 wt. percent.

FIG. 8 shows a combined spectrum of Cr and Ni doped in a forsterite glass-ceramic according to one compositional embodiment with Cr levels at about 0.05 wt. percent.

FIG. 9 shows the output spectrum of a Ni-doped glass-ceramic fiber according to the present invention. The spectrum has a center peak wavelength of about 1250 nm, and a full-width half-maximum (FWHM) of about 250 nm.

FIG. 10 is a schematic representation of a fiber-based device that may be used for optical coherence tomography (OCT) or optical coherence domain reflectometry (ODCR).

FIG. 11 shows the fluorescence spectrum of a Cr³⁺-doped glass fiber according to the present invention. The spectrum exceeds 200 nm in width and has a spectral maximum at about 800 nm.

### DETAILED DESCRIPTION

According to the present invention, a broad flat source covering a large bandwidth with low ripple can be achieved in either a single material body or by combining the output from, for instance, multiple fibers or other devices that may incorporate two or more broad fluorescence spectra. These kinds of spectra are derived from one or more species of transition metal ions doped in a material body made from a material selected from the group consisting of crystalline, glass-ceramic, glass, and organic-polymer matrices. Rear-earth metal ions with optical functionality may also be doped within. An aspect of the present invention is preferably to use the varied spectra of transition metal ions to generate a spectrum of unusually broad width over key portions of the near infrared electromagnetic region. A broadband source and associated devices (e.g., optical waveguide, fiber, or amplifier) can generate a very broad fluorescence spectrum in the infared wavelengths. Spectral ranges may span from about 500 nm through about 1550 nm. Although, specific spectral parameters would depend on the particular transition metals and/or the particular material body or bodies employed, particularly good output can be achieved in the ˜500-850 nm or ˜1300-1550 nm regions.

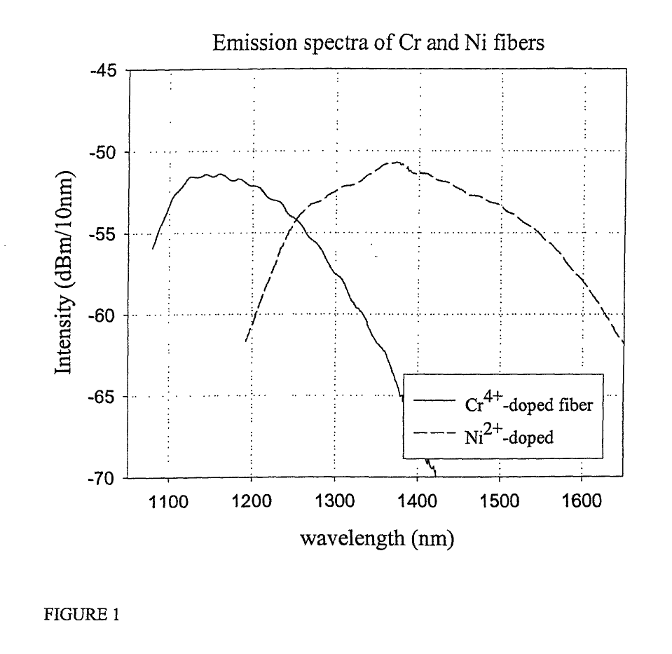

When one or more of the material bodies contain more than one species of transition-metal ions, the source produces a broad combined-output spectrum in the near infrared region when optically activated. As FIG. 1 illustrates, a combination of the relatively broad fluorescence spectra of Cr⁺⁴ and Ni⁺², for example, can produce an output spectrum that spans over about 350-430 nm, in the region from about 1170 nm to about 1550 nm, while maintaining a relatively level or flat intensity that does not deviate from an average intensity by more than 5 dB.

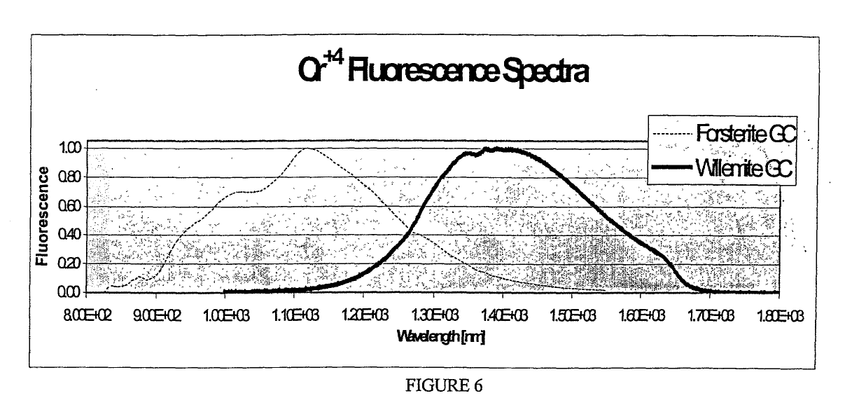

In an embodiment of the present invention, the same kind of transition metal ions is doped in two different kinds of material substrates. An example of this embodiment is illustrated in FIG. 6. FIG. 6 shows the relative spectra of Cr⁺⁴ doped in two different material substrates, such as forsterite and willemite glass-ceramic bodies. Depending on the specific material in which they are incorporated, Cr⁺⁴ ions can emit two separate fluorescent spectra of relatively equal intensity, which in combination ranges over a spectral region of from about 800 nm to about 1700 nm, with a half-bandwidth of from about 950 nm to about 1580 nm.

According to another embodiment, the device can be made using a body formed of a single kind of material doped with two or more kinds of transition metal ions. As an example, forsterite glass-ceramics can be co-doped with Cr⁺⁴ and Ni⁺². When co-doped with Cr₂Oₓ (˜0.15 wt. %), the luminescence intensity of Ni⁺² in forsterite appears to increase by roughly a factor of three. Because nickel in forsterite shows a broad luminescence, centered at about 1450 nm, covering the entire telecommunications band, it is important to increase the activity of nickel ions. When helping to increase the longer wave Ni⁺² emission, one should be aware that the luminescence intensity of Cr⁺⁴, with a band centered at about 1175 nm, could be decreased if much of the Cr⁺⁴ emission is pumped into the Ni⁺² absorption at about 1200 nm. But this is unlikely. Since the Ni⁺² ion can enter the octahedral sites and the Cr⁺⁴ is incorporated into tetrahedral sites in forsterite crystals, the two luminescent ions are unlikely to be in competition and may act synergistically to emit a flat combined broad spectrum. Forsterite crystals tend to be in a slightly distorted configuration, thus permitting emission from nickle ions.

Table 1 presents three compositional examples of forsterite in terms of weight percent as batched. The compositional examples differ from one in another in the amount of Cr₂O₃ present in each batch.

TABLE 1
Example Compositions of Co-doped Fosterite

| Oxides Batched (wt. %) | Ex. Y | Ex. X | Ex. Z |
|---|---|---|---|
| SiO₂ | 43.5 | 43.5 | 43.5 |
| Al₂O₃ | 17.8 | 17.8 | 17.8 |
| MgO | 17.5 | 17.5 | 17.5 |
| K₂O | 16.5 | 16.5 | 16.5 |
| TiO | 4.8 | 4.8 | 4.8 |
| NiO | 0.30 | 0.30 | 0.30 |
| Cr₂O₃ | 0.10 | 0.05 | 0.15 |

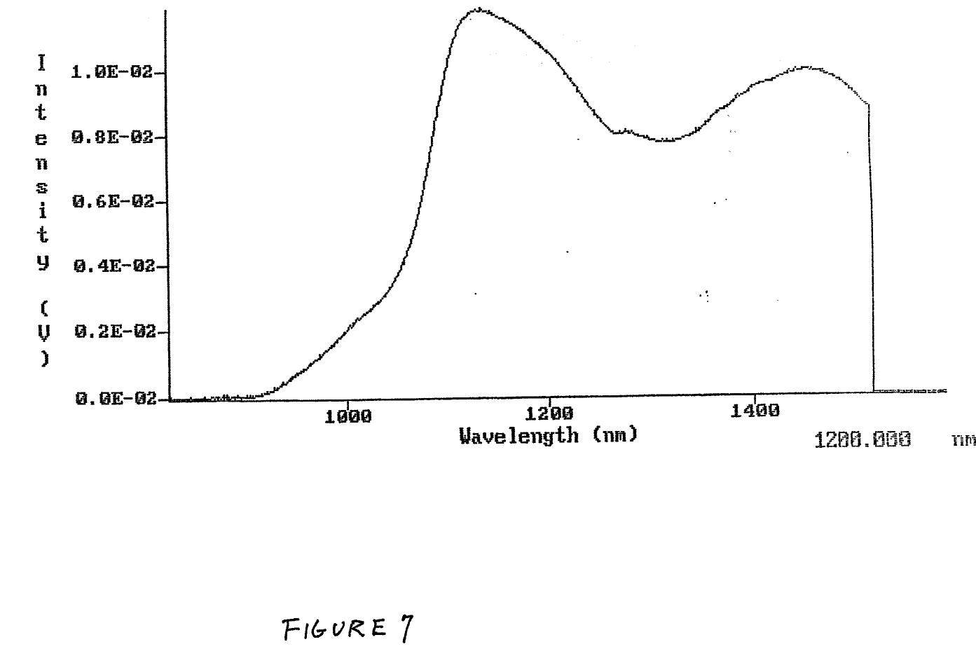

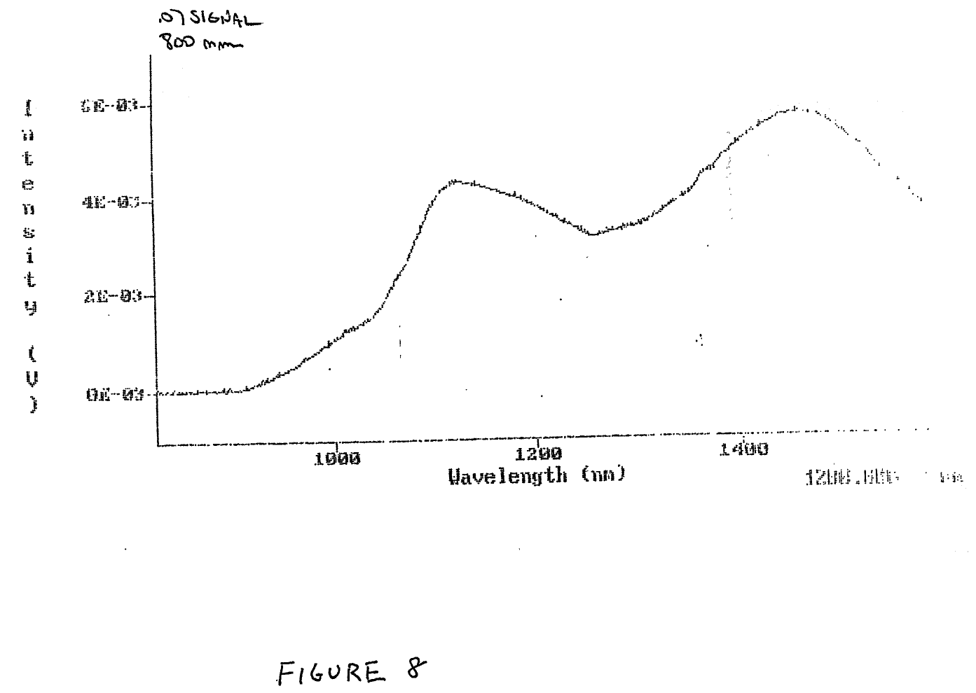

FIG. 7 depicts a combined spectrum emission from a glass-ceramic formed according to Example Y, and FIG. 8 shows a combined spectrum emission from a glass-ceramic formed according to Example X. As one can see, both compositional examples can produce fairly high fluorescent intensity (y-axis—in arbitrary units), and rather broad output spectra over a total span in wavelength of at least about 400 nm to 500 nm (x-axis—nm) in the near infrared region. Empirically, to achieve a better, more level combined spectrum, the amount of Cr₂O₃ likely will be present at levels about 0.70-0.85 weight percent, if the NiO concentration is maintained constant. Those in the art will understand that various combinations and amounts of the two fluorescent dopants can be adjusted to optimize flatness and breadth of the combined spectrum.

Another species of applicable materials includes glass-ceramics like transparent gallate spinels doped with transition metal ions. Table 2 presents some representative examples of nickel-doped gallate spinel with compositions, in weight percent, of about 36-45% SiO₂; ˜20-43% Ga₂O₃; ˜7-22% Al₂O₃; ˜11-16% K₂O; 0-2.5% Li₂O; 0-11% Na₂O; ˜4-6% La₂O₃; ˜1-2% MgO. The undoped, basic gallate spinel compositions are typically heat-treated between about 800-900° C. for about 1-2 hours.

TABLE 2
Example Compositions of Ni-doped Gallate Spinel

| Oxides (wt. %) | Ex. A | Ex. B | Ex C | Ex. D | Ex. E | Ex. F |
|---|---|---|---|---|---|---|
| SiO₂ | 38.6 | 44.4 | 37.3 | 38.7 | 39.6 | 41.3 |
| Ga₂O₃ | 25.1 | 21.4 | 30.6 | 42.3 | 31.0 | 22.8 |
| Al₂O₃ | 16.2 | 20.4 | 13.3 | 7.7 | 15.9 | 21.8 |
| K₂O | 15.1 | 12.0 | 12.3 | — | 11.5 | 12.0 |
| Li₂O | — | 1.8 | — | 1.3 | 2.0 | 2.1 |
| Na₂O | — | — | — | 10.0 | — | — |
| La₂O₃ | 4.0 | — | 5.3 | — | — | — |
| MgO | 1.0 | — | 1.1 | — | — | — |
| NiO | 0.05 | 0.05 | 0.5 | 0.5 | 0.5 | 0.5 |

Other specific Li(Al,Ga)₅O₈ or “γ-(Al,Ga)₂O₃” spinel compositions are disclosed in co-assigned, patent application Ser. No. ______ (Corning Docket No. SP01-123) ______, the contents of which are incorporated herein by reference.

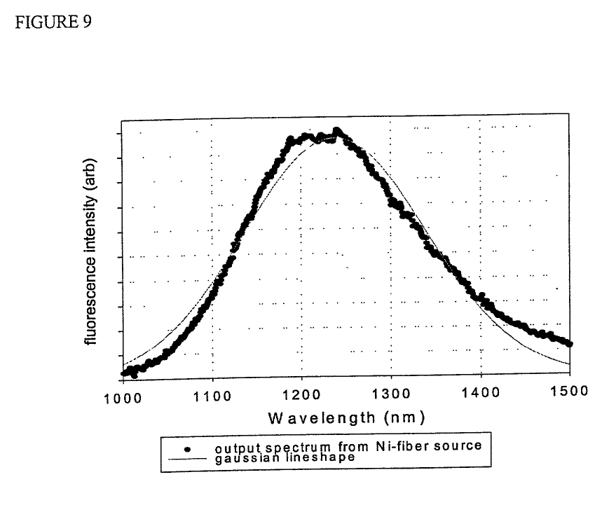

The composition examples have been fiberized and evaluated for their properties for broadband source application. The details of the particular fluorescence spectrum for the examples appear to depend on the heat treatment given the fiber. One example achieved a spectrum of about 250 nm full-width half-maximum (FWHM), with a peak at about 1200 μm, having a smooth more “gaussian lineshape,” instead of a series of sharp peaks at longer wavelength, as the crystallization temperature increases. A graphical illustration of this type of phenomenon can be seen in FIG. 9. By comparison, a non-crystallized fiber containing Ni²⁺ ions in a glass environment provides no measurable fluorescence. As optimal heat treatment is approached, the fluorescence efficiency and lifetime for the active Ni²⁺ ions increases dramatically. This feature is summarized in Table 3, which lists the measured room-temperature lifetimes for different heat treatments and the peak fluorescence wavelengths.

TABLE 3
Dependence of Ni-ion lifetime in glass-ceramic fibers with ceramming schedule.

| Heat Treatment | 1^{st} “e” folding time | | 2^{nd} “e” folding time | | Peak Wavelength |
|---|---|---|---|---|---|
| 750° C. for 2 hrs. | 210 | μs | 400 | μs | 1350 nm |
| 800° C. for 2 hrs. | 780 | μs | 1.2 | ms | 1250 nm |
| 850° C. for 2 hrs. | 1.1 | ms | 1.3 | ms | 1200 nm |

One observes a shift in the fluorescence to higher energy levels upon ceramming the fiber. It is believed that these systematic changes in the Ni²⁺-ions spectroscopy are associated with a change in the electron-phonon coupling of the ions, presumably as they become incorporated into the crystalline environment rather than the original glass matrix.

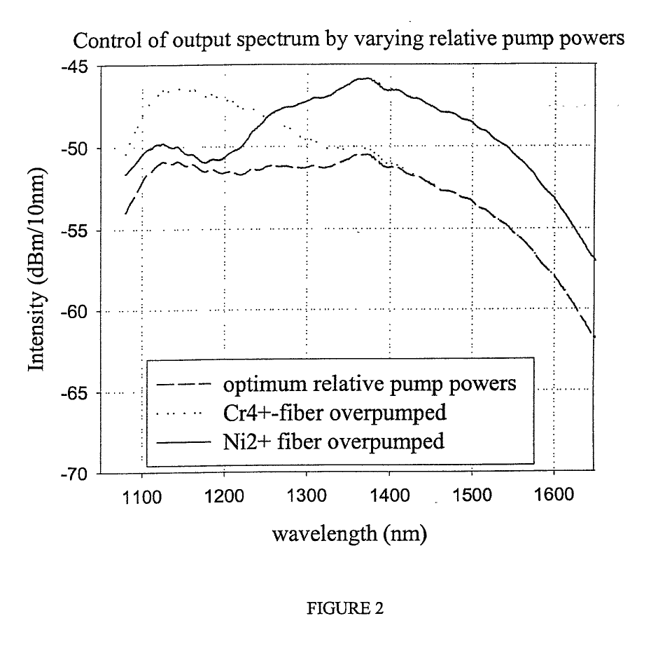

To achieve an optimal flatness in the output spectrum, the relative pump power and intensity employed with the respective transition metal containing materials or media should be controlled. Relative control of the intensity and fluorescence characteristics could be optimized by variation in the relative powers, which will depend on the specific material, its composition, and concentration of specific transition metal ions in the respective media as desired. FIG. 2 shows examples of this phenomenon, where possible over-pumping of either fiber can lead to excessive signal in the wavelength band. The fibers, which contain the transition metal ions, are pumped in a fashion such that neither has a differential-in-intensity peak of ≧about 2-20 dB or about 1-40% of maximum intensity, depending on the particular desired application.

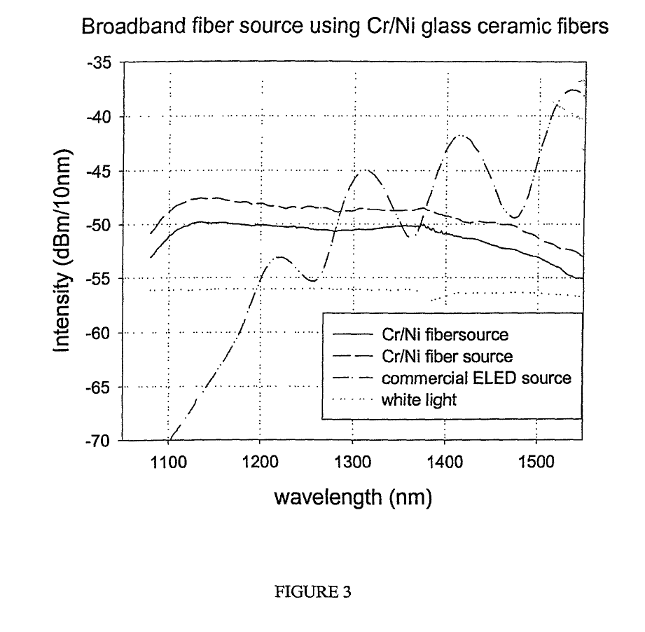

An embodiment of the present invention illustrating the basic concept is the fluorescence spectra, shown in FIG. 2 or 3, of Cr⁺⁴-doped and Ni⁺²-doped glass ceramic fibers when pumped with a 980-nm laser. The Cr⁺⁴-doped fiber, exhibits a fluorescence maximum peak at about 1150 nm, and the Ni⁺²-doped fiber exhibits a maximum peak at about 1400 nm, with the exact peak and line-shape strongly dependent on the exact composition of the glass-ceramic material. As mentioned before, the relative pump powers between the two fibers need to be controlled to achieve an optimal flatness in the output spectrum. FIG. 3 shows in comparison the output spectrum for a broadband device and two different pump powers, along with examples of the spectrum obtained from the current technologies. The back fluorescence of transition metal-doped glass-ceramic fibers combined in wavelength division multiplexes (WDM) is shown. The broadband source has a better and flatter spectral response than the ELED source, and a higher power or intensity than the pigtailed white light source.

Empirical tests have shown that the present broadband source and devices utilizing the source can achieve a significantly broad spectrum that could be used to replace multiple ELED sources. In an example, about 3 ELEDs would be necessary to cover the spectral range of a nickel and thulium or erbium doped fiber according to the present invention, which has a combined bandwidth of about 450 nm over about 1100-1550 nm. The source doesn't deviate from an average intensity by more than ˜5 dB.

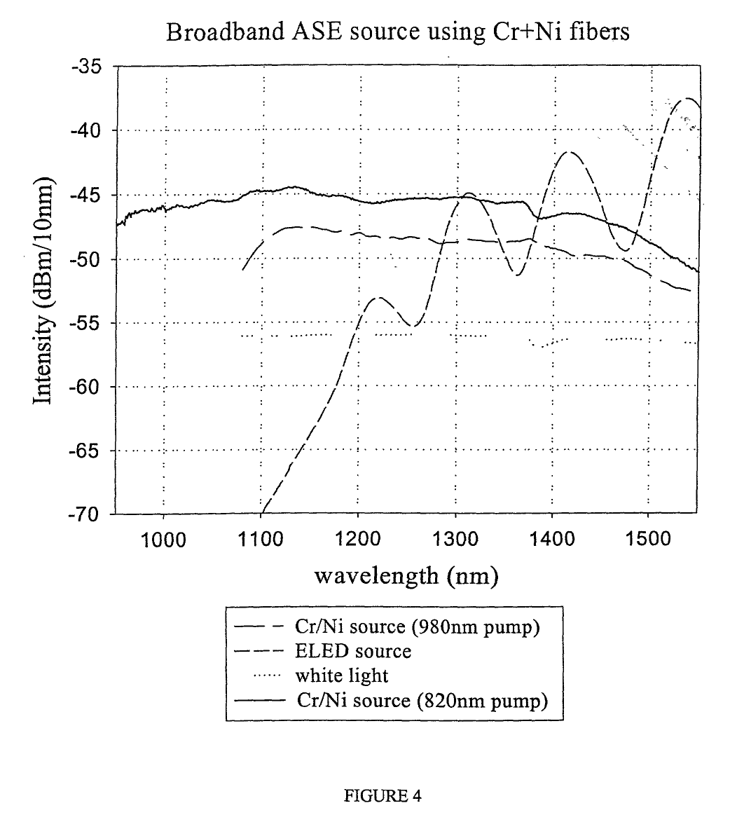

Additionally, the exact wavelengths at which the media are optically energized could be a factor, illustrated in FIG. 4. FIG. 4 shows a comparison of the relative breadth and intensity of combined Cr- and Ni-doped media, as laser energized or pumped at 980 nm and at 820 nm. The combined media energized at 820 nm exhibits only about a 5 dB ripple over about 600 nm of bandwidth, from approximately 950 μm to about 1550 nm. Improvement in the short wavelength performance can be achieved by pumping at other wavelengths, such as 630 nm. Lasing at about 800-820 nm fills-in the wavelengths shorter than about 1400 μm rather well, in that it increases the breath of the spectrum by about an additional 100 μm. This feature is likely due to the fluorescence of Cr⁺³ ions, since Cr⁺³ ions are not as excited by pumping at 980 nm.

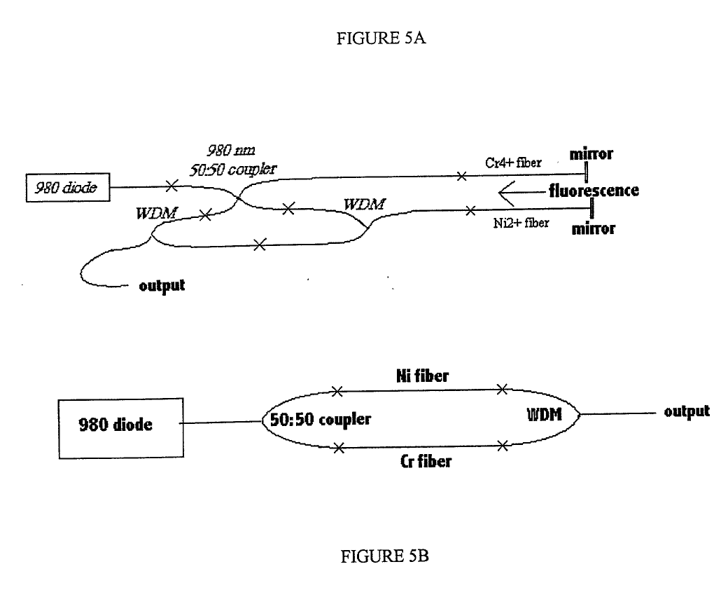

Other possible methods can be envisioned for controlling the flatness of the spectrum. These methods may include setting the pump splitter coupler to a particularly advantageous ratio. The wavelength response of the pump splitter coupler can be used to control the relative amount of pump power going to each fiber, such that by tuning the pump wavelength by some tens of nanometers significant variation in the pump distribution can be achieved. In the example illustrated in FIGS. 5A and 5B, the ratio is set at 50:50 but this could easily be 80:20, 70:30, 60:40, or any variant in between. Another approach could be to incorporate variable optical attenuators (VOAs) into the output arms of the pump splitter coupler, thus allowing the flatness to be controlled after the device is manufactured. Alternatively, separate pump lasers can be employed to excite the different doped fibers, such that by simply varying the output power from each pump the overall flatness can be controlled. These approaches are merely given as illustrative examples, and in no respect limit the present invention.

FIGS. 5A and 5B show schematic representations of alternate embodiments of other fiber devices, which can be used to combine the fluorescence spectra. Alternatives to these designs can and are intended to be included within the scope of the present disclosure. For instance, useful applications for fiber based broadband sources may include a device to characterize loss spectrum in fiber based components (e.g., gratings, couplers as well as doped fibers for transmission and amplifiers). Optical signal devices incorporating glass-ceramic gain media are described in U.S. Pat. No. 6,297,179, the content of which is incorporated herein by reference.

Other devices that incorporate the broadband source may include equipment for characterizing the transmission of fibers or fiber based components. According to such an application an increased power output can lead to an improvement in the dynamic range of measurements, shorter measurement times with less averaging, and higher resolution. For some broadband source and device embodiments that have one material body containing one or more species of transitional-metal ions, the resultant output spectrum can be very broad in of themselves. As mentioned above, FIG. 9 represents an example of the invention with an output spectrum from a nickel-doped glass ceramic fiber having the desirable properties of a peak wavelength centered on about 1250 nm, broad spectral bandwidth (˜250 nm FWHM), and smooth line-shape.

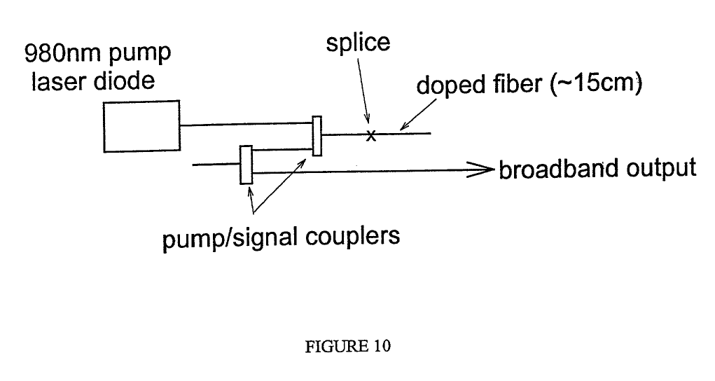

A broadband source can also be useful when applied to the field of OCT. An optimized device exhibits a high spatial coherence, high brightness and broad bandwidth, the final parameter controlling the depth resolution of the device. Such properties may find welcome use in biological imaging devices. A device like that shown in FIG. 10, which uses a 980 nm pump laser diode, is particularly useful in the emerging field of OCT, because it is relatively inexpensive, compact, and an all-fiber source. Furthermore, the spectrum generated is centered at a desirable wavelength away from any strong water absorption peaks, and has a near gaussian line-shape making signal processing of the interferogram relatively easy. The large FWHM of this source offers significant improvements in spatial resolution when used in either OCT or OCDR systems.

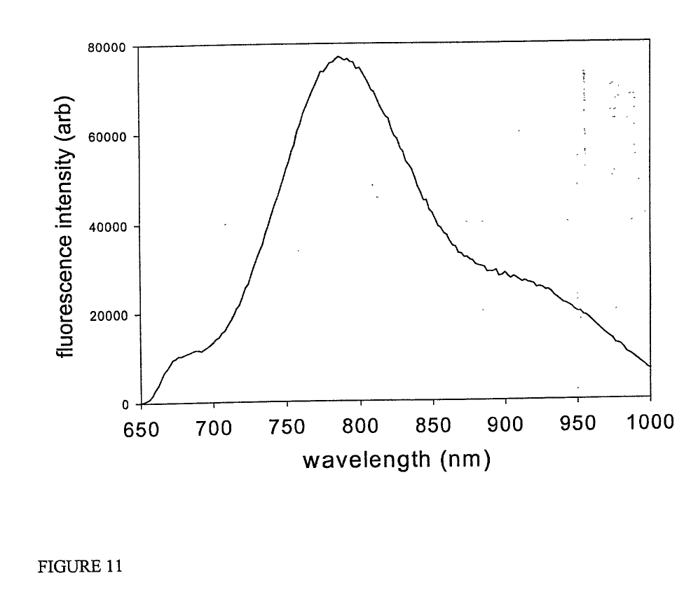

Transition metal-doped fibers offer the potential of resolutions less than 5 microns. In comparison, devices available currently utilize super-luminescent diodes as the luminescence source and achieve resolutions only around 8-20 microns due to the relatively low bandwidth (usually <70 nm). For future OCT applications a broadband source centered on the 800 nm wavelength is much desired, but resolution capabilities need to be improved from current levels. For instance, 800 nm diodes are employed in particular systems that image eyes with OCT technology but only with a relatively low resolution, because the diodes provide a narrow spectral bandwidth. The present invention provides a solution to this problem. FIG. 11 shows the output from another example of a broadband source that may be useful for OCT systems. The broad spectrum from a Cr⁺³-doped glass fiber is centered around 800 nm and exceeds 200 nm in width. Other adjustments can improve the line-shape of these broadband fiber sources. These adjustments may include filtering the output spectrum using a bandpass filter for example, which could be used to improve the gaussian line-shape even further.

As described before, devices according to current technology are based on single or multiple laser diodes, rare earth doped fiber ASE (amplified spontaneous emission) sources, thermal white light sources, continuum generation utilizing short pulse (fsecs) lasers or rapid wavelength tuning of the output from various lasers. None of these technologies exhibit the desired bandwidth of a broadband source according to the present invention, such as a fiber-based embodiment, with accompanying advantages of being a significantly simpler and less expensive device.

Another application for using broadband source includes spectral sliced source for wavelength division multiplexed (WDM) system applications. Currently, the ASE spectrum from erbium doped fibers has been used to show the potential for this low cost source transition system, mainly for short haul and metro systems. The trade-off in bit rate and optical bandwidth per channel means that a 10 Gb/s data rate would require around 3 nm of optical bandwidth per channel, hence a 20 channel system would require over 60 nm of bandwidth from the ASE source. The use of transition metal-doped waveguides or fibers could easily meet and exceed this broadband ASE criterion allowing higher bit rates and/or more channels.

Although the present invention has been described by way of examples, it will be understood by those skilled in the art that the invention is not limited to the embodiments specifically disclosed, and that modifications and variations can be made without departing from the spirit and scope of the invention. Therefore, unless changes otherwise depart from the scope of the invention as defined by the claims that follow, they should be construed as included herein.

We claim:

1. A broadband source comprising at least one body containing one or more species of transition-metal or rare-earth metal ions, wherein the source produces a broad output spectrum of about at least 150-250 nm bandwidth in a near infrared region, when optically energized.

2. A broadband source comprising at least one body containing one or more species of transition-metal ions, wherein the source produces a broad combined-output spectrum with an intensity that does not deviate from an average intensity by more than ±10 dB, in a near infared region, when optically energized.

3. The source according to claim 1, wherein when the body contains more than one species of transition-metal ions, the source produces a broad combined-output spectrum in the near infrared region when optically activated.

4. The source according to claim 1, comprising a material selected from the group consisting of crystalline, glass-ceramic, glass, and organic-polymer matrices.

5. The source according to claim 1, comprising a glass-ceramic material.

6. The device according to claim 4, wherein said material is a transparent forsterite body.

7. The device according to claim 4, wherein said material is a transparent gallate spinel body.

8. The device according to claim 4, wherein said material is a transparent willemite body.

9. The source according to claim 1, wherein said source is incorporated into an optical component device.

10. The source according to claim 9, wherein said device is an optical waveguide.

11. The source according to claim 9, wherein said device is an optical fiber.

12. The source according to claim 9, wherein said device is an amplifier.

13. The source according to claim 9, wherein said device is an optical energizer.

14. The source according to claim 9, wherein said device is used for OCT or OCDR.

15. The source according to claim 1, wherein said transition-metal ions are selected from a group consisting of: Co⁺³, Cr⁺³, Cr⁺⁴, Cu⁺², Cu⁺, Ni⁺², Ti⁺³, and V⁺².

16. The source according to claim 1, wherein said source produces a combined-output spectrum of a relatively level intensity, between about 800 nm to about 1800 nm.

17. The source according to claim 16, wherein said source produces a combined-output spectrum of a relatively level intensity, between about 1050 nm to about 1580 nm.

18. The source according to claim 2, wherein the source further comprises rare-earth ions in said body.

19. The source according to claim 18, wherein said rare earth ions include Er, Tm, Pr, or Nd.

20. A broadband source device comprising at least one body containing one or more species of transition-metal ions, wherein the device produces a broad output spectrum in a near infrared region when optically energized.

21. The device according to claim 20, wherein when said body contains more than one species of transition-metal ions, said device produces a combined-output spectrum with an intensity that does not deviate from an average intensity by more than ±10 dB.

22. The device according to claim 20, wherein said device has a body made from a material selected from the group consisting of crystalline, glass-ceramic, glass, and organic-polymer matrices.

23. The device according to claim 20, wherein said device has a body made from a glass-ceramic material.

24. The device according to claim 20, wherein said device is an optical component device.

25. The device according to claim 23, wherein said device is an optical waveguide.

26. The device according to claim 23, wherein said device is an optical fiber.

27. The device according to claim 23, wherein said device is an amplifier.

28. The device according to claim 23, wherein said device is an optical energizer.

29. The device according to claim 23, wherein said device is used for OCT or OCDR.

30. The device according to claim 20, wherein said transition-metal ions are selected from a group consisting of: Co⁺³, Cr⁺³, Cr⁺⁴, Cu⁺², Ni⁺², Ti⁺³, and V⁺².

31. The device according to claim 20, wherein said device produces a combined-output spectrum of a relatively level intensity between about 800 nm to about 1800 nm.

32. The device according to claim 31, wherein said device produces of a combined-output spectrum of a relatively level intensity between about 1050 nm to about 1580 nm.

33. The device according to claim 20, wherein the device further comprises rare-earth ions in said body.

34. The device according to claim 33, wherein said rare earth ions include Er, Tm, Pr, or Nd.

35. A device having a broad, simultaneous wavelength range, the device comprising a material doped with transitional-metal ions that exhibit relatively broad fluorescence of about at least 150-250 nm wide, wherein the device emits a combined spectrum having an intensity that does not deviate from an average intensity by more or less than about 10 dB, over a range from about 800 nm to about 1800 nm.

36. The device according to claim 35, wherein said intensity does not deviate from said average intensity by more than about 5 dB.

37. A method for making a broadband source device comprising: providing at least one material containing transition-metal ions, forming said material into an optical component, energizing said transition metals in said material, and emitting a broad, combined fluorescence having an intensity that does not deviate from an average intensity by more or less than about 10 dB, in a spectral region greater than or equal to about 700 nm.

38. The method according to claim 37, further comprising two different material substrates as a body or bodies doped with the same kind of transition metal ions.

39. The method according to claim 37, further comprising providing two or more bodies containing more than one species of transition metal ions.

40. A method of producing an optical emission, the method comprises providing at least one material body having at least one or more species of transition metal ions, energizing the body to produce a relatively broad combined-output spectrum of a relatively level intensity, in a near infrared region.

41. The method according to claim 40, may further comprise producing an emission that has an intensity that does not deviate from an average intensity by more than about 10 dB or less, between a spectrum range from about 900-1560 nm.

42. The method according to claim 40, may further comprise providing a body made from a material selected from the group consisting of crystalline, glass-ceramic, glass, and organic-polymer matrices.

43. The method according to claim 40, wherein the material body may be doped with transition metal ions selected from a group consisting of: Co⁺³, Cr⁺³, Cr⁺⁴, Ni⁺², Ti⁺³, and V⁺².
